(19) United States
(12) Patent Application Publication
(10) Pub. No.: US 2013/0181658 A1
(43) Pub. Date: Jul. 18, 2013

(54) Control of electrical power used to charge an energy storage device

(71) Applicant: Carl Lee Danner, Bakersfield, CA (US)

(72) Inventor: Carl Lee Danner, Bakersfield, CA (US)

(21) Appl. No.: 13/350,950

(22) Filed: Jan. 16, 2012

(51) Int. Cl. H02J 7/00

(52) U.S. Cl. 320/107

(57) ABSTRACT

In a first embodiment an electrical power request is sent to a energy storage device charger. This charger uses a controllable power source that supplies requested power. The electrical power request may be created in various ways. The request may be programmed into a power-requesting device or the power-requesting device may develop the request using information about the device to be charged. One programmable requesting device may be used for all energy storage devices or each energy storage device may use it own power-requesting device that develops a power request specific to the energy storage device.

In a second embodiment a power-requesting device develops the power request based partly on sensor information from the energy storage device.

In a third embodiment the power delivery plug is selectable.

### REFERENCES CITED

### U.S. Patent Documents

| | | |
|---|---|---|
| 7,844,370 | November 2010 | Pollack |
| RE41675 | May 2006 | liu |
| 7,414,332 | August 2008 | Ohsuga |
| 7,411,371 | August 2008 | Hobbs |

### FIELD OF THE INVENTION

This invention relates to devices that store energy provided by an electrical power source.

### BACKGROUND OF THE INVENTION

Some prior art electric chargers do not provide electrical power that an energy storage device can control. Other prior art chargers require the energy storage device to control the charger. If a code were used to control the charger a different code would be needed for each type charger since different control methods would be needed. The only way that one code could be used is if that code were translated to a control signal the charger could use. It is therefore object of the present invention to provide an energy storage device charger that responds to requests for power wherein power parameters are specified. Any charger of the present invention would supply the correct power since the charger is responding to a power request rather than a control signal that may change with each charger. There are many types of energy storage devices that need controllable electric power. There are hydrogen tanks that need to use electricity to create hydrogen. There are ultra capacitors. There are many types of chemical energy storage devices. The energy storage device being charged may need a pulsed direct current, or power having a saw tooth waveform. The energy storage device may need a certain voltage. Almost all energy storage devices use direct current but the device may be in an electric vehicle that uses an alternating current paddle feed so the charger will need to provide alternating current. The charger should be able to control power parameters so as to satisfy most requests. Versatile power delivery methods, power request methods, communication protocols etc. are needed. There are many and varied ways of solving these problems.

Another object of the invention is to use one device charger to charge devices that normally cannot use the same charger. Typically these devices may use power plugs that are specific to the energy storage device.

Therefore the charger should be able to provide the requested power at a correct type of plug or other power transfer device.

Another object of the invention is to use very few different type plugs. Each plug would be able to charge many different types of energy storage devices each of which possibly requiring power that would damage the other energy storage devices.

### SUMMARY OF THE INVENTION

In accordance with these and other objects of the invention,

in a first embodiment there is provided a controllable power source that delivers requested power. A programmable power-requesting device requests the power. The programmable power-requesting device is reprogrammed with a new power request each time an energy storage device having different power requirements is being charged.

In a second embodiment a requesting device is removable. Each requesting device has information that is matched to the energy storage device so as to request the power that the energy storage device needs but the requesting device is not monitoring the energy storage device or the power that is being provided.

In a third embodiment there is provided the same equipment as in the first embodiment but the requesting device is also monitoring power that is being provided. This additional information is used to develop a power request that improves charging of the energy storage device. It is not monitoring energy storage device parameters such as temperature.

In a fourth embodiment there is provided the same equipment as in the first embodiment but the requesting device is also monitoring energy storage device parameters such as temperature or the amount of hydrogen in a tank. The requesting device is not monitoring power that is being provided.

In a fifth embodiment there is provided the same equipment as in the first embodiment but the requesting device is monitoring power that is being provided and it is also monitoring energy storage device parameters such as temperature.

In a sixth embodiment is provided the same equipment as in one of the first five embodiments but there are provided multiple power delivery methods. These methods allow a controllable power source to provide power to devices that use non-compatible power delivery methods adapted to the parameters of the type power that is being delivered. Since existing plugs usually provide a specific voltage it may be necessary to use a new type plug so a device will not accidentally be provided incorrect voltage.

In a sixth embodiment is provided the same equipment as in the fifth embodiment except a new controllable power source has been provided that is able to monitor power delivery plugs to see if a device is attached. Thus the requested power can be delivered at any plug that has the ability to deliver that power. If the plug does not have the ability to handle the requested power then the controllable power source may be able to provide another power as long as it decides that the power will not damage the energy storage device. This scenario is unlikely however since there may be liability issues that make it impractical. It is more likely that the ability to monitor power delivery plugs will be used to delay activating a plug until there is an energy storage device attached.

In a seventh embodiment is provided the same equipment as in the fifth or sixth. Now a new controllable power source has the ability to reply to the power request device. The reply may repeat the type power that was requested. It may also state that the requested power is not available. An alternative power may be suggested. The power request device may use the information in the reply to make an alternative power request.

Thus one aspect of the invention contemplates energy storage device charging that uses a controllable power source that delivers requested power. Another aspect of the invention takes advantage of controllable power so that many types of devices that normally use different chargers may be charged from the same charger. Another aspect of the invention allows two way communications between the power request device and the power source so as to verify power delivery and possibly resolve problems.

### BRIEF DESCRIPTION OF THE DRAWINGS

The foregoing and other objects and features of the present invention can be more readily understood with reference to the following detailed description, taken in conjunction with the accompanying drawings. Like reference numerals designate like electrical elements. Dotted lines represent control, device status signal lines, power request signals, sensor information, or controllable source signals. Two numbers separated by a dash represent a new type of plug that is designed to transfer various voltages and currents. The first number specifies the maximum voltage in hundreds of volts. The second specifies the maximum current in tens of amperes. This convention is used in this document to identify this new type plug. Since specific energy storage devices are not being charged in this document the plug rating numbers are not important other than that a higher number would indicate a plug that is capable of conducting more power. In this document one number identifies plugs that normally conduct a specific voltage.

FIG. 1 shows a prior art charger that uses separate bays or plugs for each type device as a method of identifying which type device is being charged.

FIG. 2 shows a prior art charger that uses a controllable power source that is controlled in response to energy storage device sensor and identification information.

FIG. 3 shows an aspect of the current invention. A controllable source is delivering power in response to a power request. The power request specifies one or more characteristics of the power to be provided. A device is programmed with a request for power appropriate to the device being charged.

FIG. 4 is the same as FIG. 3 except the power request device is removable. This allows the power request device to stay with the energy storage device so that the programmable device only needs to be programmed one time. Many power request devices will be needed. At least one for each energy storage device type.

FIG. 5 is the same as FIG. 4 except the power request device is receiving information from a sensor or sensors at the energy storage device. This additional information may be used to make a better power request.

FIG. 6 is the same as FIG. 5 except the power request device is receiving information from sensors on the power deliver line and the energy storage device.

FIG. 7 is the same as FIG. 4 except the controllable power source has the ability to supply power to more than one type power plug. This takes advantage of the charger's ability to furnish power having various power parameters.

FIG. 8 is the same as FIG. 7 except the controllable power source is monitoring the power delivery plugs to see if an energy storage device is attached.

FIG. 9 shows many of the features described in previous figures. It adds more power-requesting devices and two-way communications to the controllable power source. This allows the controllable source to charge more than one energy storage device simultaneously.

### DETAILED DESCRIPTION OF THE INVENTION

It should be understood that although the invention is described with reference to providing electrical power to an energy storage device, it is contemplated that the principles of the invention may be employed to provide power to other types of equipment or to providing other types of power. Use of the present invention with large mining equipment or other powered machinery may allow for more efficient control of power.

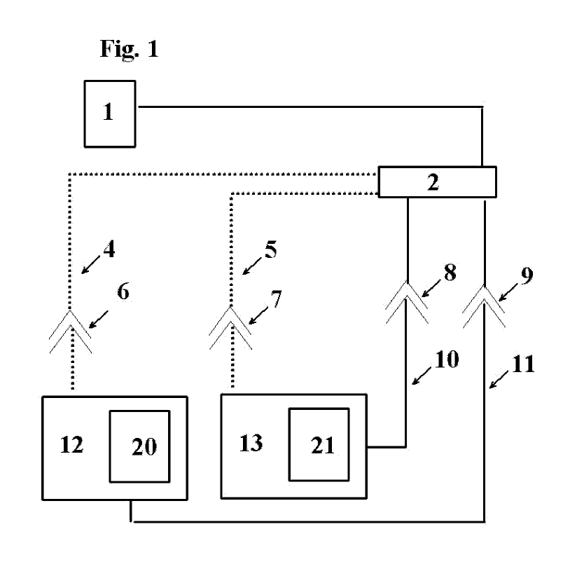

Referring now to FIG. 1 of the drawings, a block diagram of a device charger that is using prior art technology is shown. This is being done so that the improvements of the present invention can be more easily understood as compared with prior art. Power source 2 is created from a main power feed 1. Source 2 may receive information 4 and 5 via jack and plug connections 6 and 7. In a typical prior art design energy storage devices of different sizes 20 and 21 will fit into slots 12 or 13 and the device electrical connection may be used to provide device voltage. Power source 2 may respond to the presence of voltages 4 or 5 to provide an adjusted power 10 or 11 or power 10 or 11 may always be available at slots 12 and 13 without being modified by information 4 or 5.

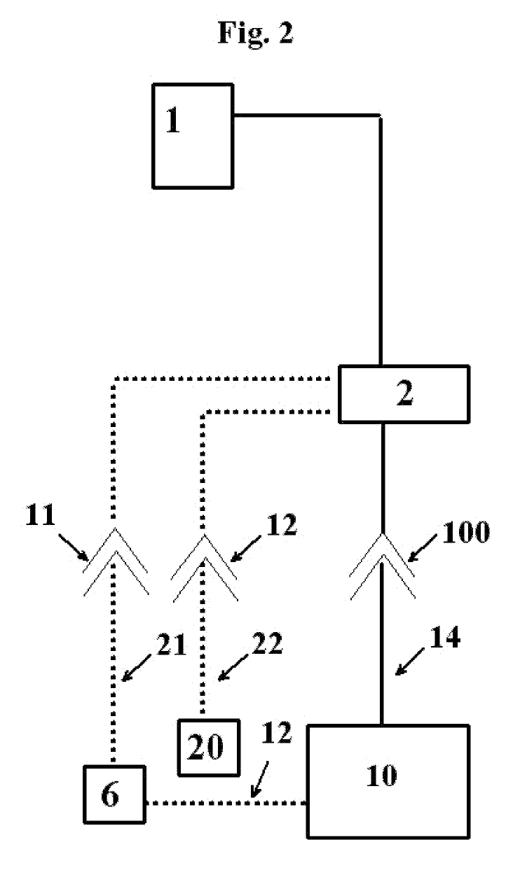

Referring now to FIG. 2 of the drawings. A block diagram of a device charger that can charge many types of energy storage devices but that is not controllable by the energy storage devices is shown. A controllable source 2 is created from a main power feed 1. Source 2 receives information 21, which may be created by device 6 based on sensor information 12. Source 2 may also receive energy storage device 10 identification information 22 that has been put in device 20. Many types of energy storage devices can be charged with this charger because sensor information 21 would tell source 2 something about device 10 condition. Also many device identification numbers 22 could be used. Source 2 uses this information charge various energy storage devices 10 using power 14 via plug 100. This embodiment suffers from the limitation of requiring source 2 to have information about the power requirements of many device numbers 22. Some prior art puts energy storage device information in device 20. Device 20 then sends source 2 control signals 22 instead of device numbers at 22. The control signals 22 must be able to control source 2. If new source 2 capabilities are added then the control signals 22 may not be able to correctly control source 2 so that it can provide a usable power 14 to device 10.

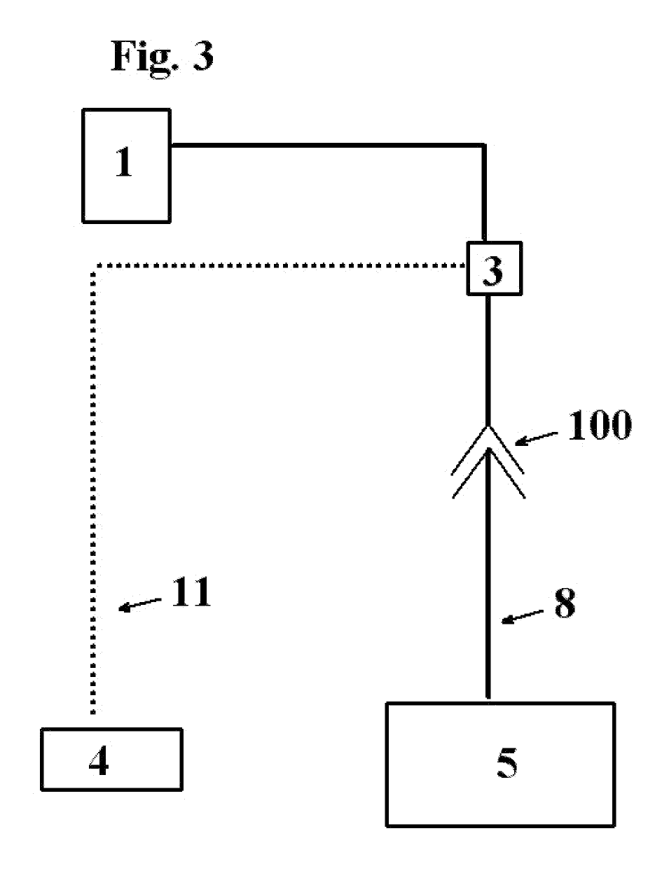

Referring now to FIG. 3. An aspect of the current invention is shown. Power-requesting device 4 develops and sends a power request 11 to controllable source 3. Controllable source 3 then controls or modifies power from power feed 1 so as to create power 8 that has the parameter or parameters specified in power request 11. Power 8 charges energy storage device 5 via plug 100. Device 4 should be able to send a power request for power that correctly charges energy storage device 5. When an energy storage device having different power requirements is plugged into plug 100 a different power request device will be programmed into power-requesting device 4 so as to request an appropriate type power.

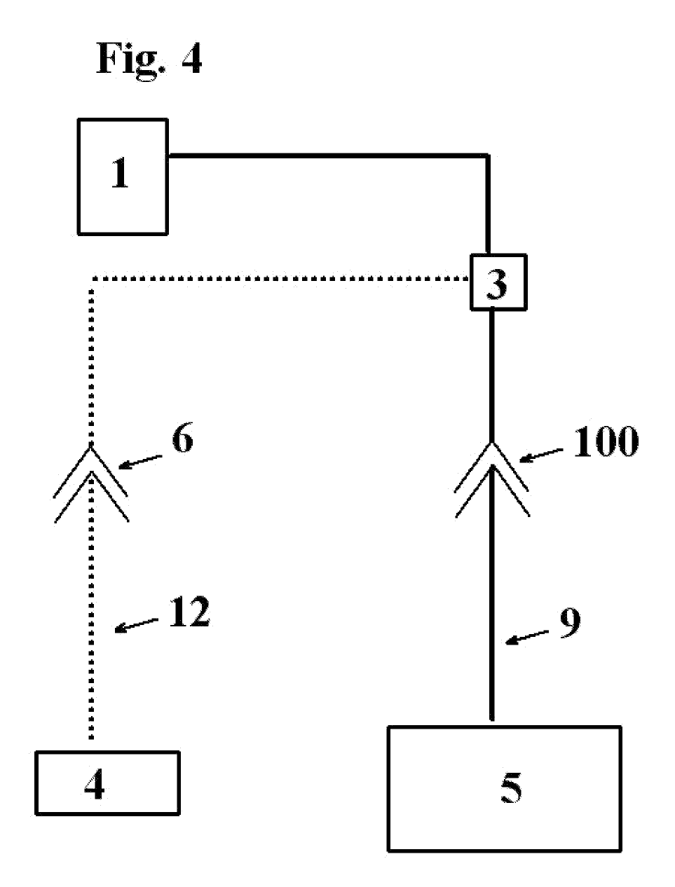

Referring now to FIG. 4. Power-requesting device 4 is now sending a power request 12 to controllable power source 3 via plug 6 to provide power 9 to energy storage device 5 via plug 100. When an energy storage device having different power needs is plugged into plug 100 a power request having different parameters will be needed. Power-requesting device 4 can be unplugged and replaced with a different power-requesting device that has been programmed with the correct power request.

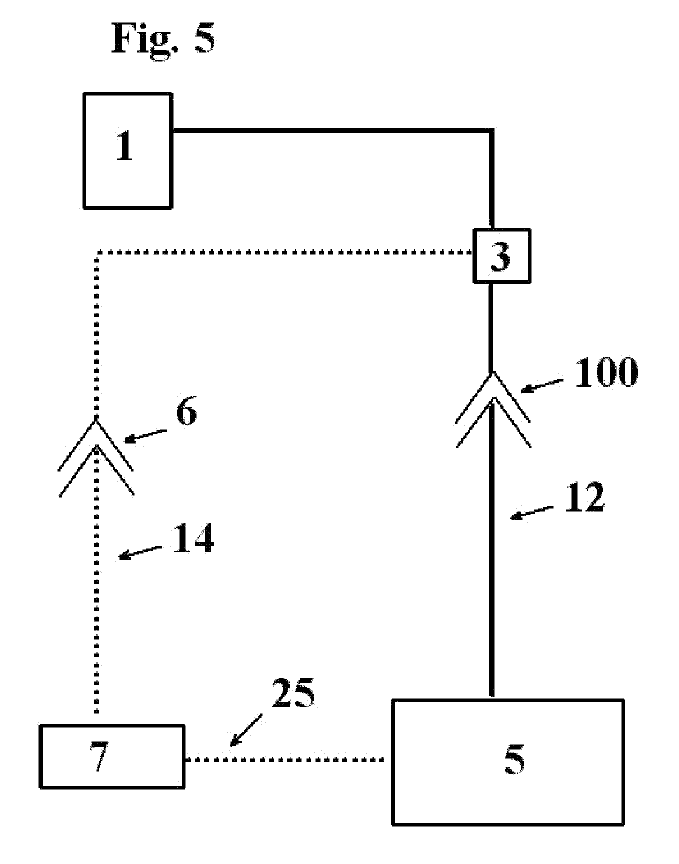

Referring now to FIG. 5. Power-requesting device 7 is receiving information 25 from a sensor or sensors on energy storage device 5. Power-requesting device 7 may have a programmed power request but the programmed power request would only be used if sensor information 25 is not available. Instead, power-requesting device 7 has information about energy-storage device 5. Power-requesting device 7 uses this information and sensor information 25 to develop a power request 14 that is sent to controllable power source 3 via plug 6. Controllable power source 3 uses power request 14 to provide a new power 12 via plug 100.

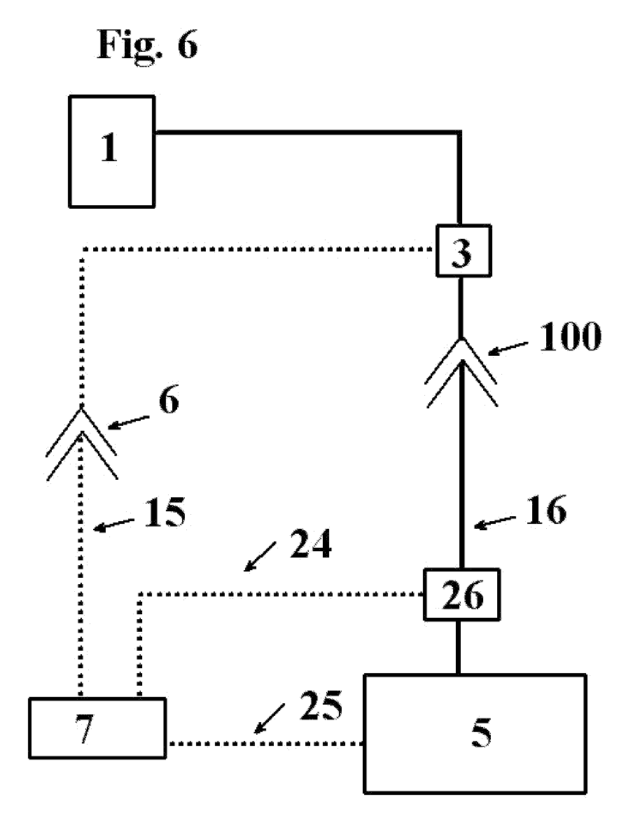

Referring now to FIG. 6. Power-requesting device 7 uses the information 24 from sensors 26 and information 25 from sensors on energy storage device 5 plus any information about energy storage device 5 that was previously entered into power-requesting device 7 to make power request 15. Controllable power source 3 now uses power request 15 to provide power 16 to energy storage device 5 via plug 100.

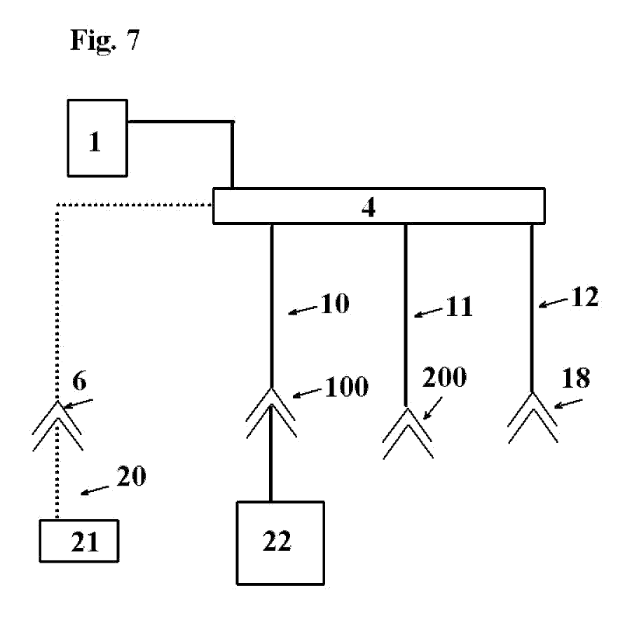

Referring now to FIG. 7. This is similar to FIG. 4 except a new controllable power source 4 is capable of providing power at plugs 100, 200, or 18. Power-requesting device 21 sends power request 20 to controllable source 4 via plug 6. Controllable source 4 then controls or modifies power from power feed 1 so as to create power 10 that has the parameter or parameters specified in power request 20. Controllable source 4 then decides which plug to energize. In this case it is plug 100. If a different power request had asked for power 11 or 12 then plugs 200 or 18 would have been energized.

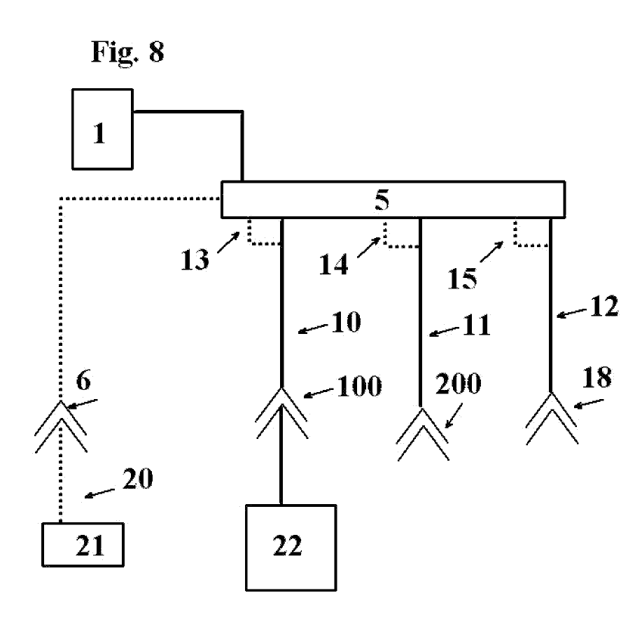

Referring now to FIG. 8. This is the same as FIG. 7 except new controllable power source 5 has the ability to monitor power lines to plugs 100, 200, and 18 to see if an energy storage device has been attached. Controllable power source 5 probably will not energize any plug until an energy storage device has been attached even if controllable power source 5 has determined that power request 20 has specified a power that should be on plug 100. This is done for safety.

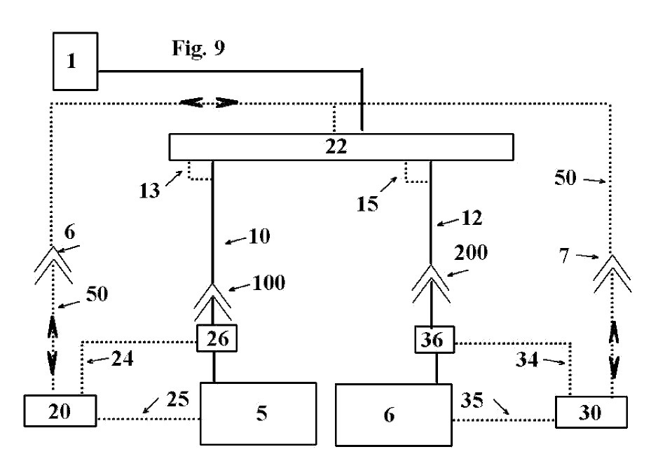

Referring now to FIG. 9. This shows many of the features shown in previous figures. It also adds two-way network communications 50 between power-requesting devices 20 and 30, and controllable power source 22. This allows controllable power source 22 to charge energy storage devices 5 and 6. There are many advantages if all devices are more intelligent. For example, let's say that sensors 26 do not detect power 10. Power-requesting device 20 can inform controllable power source 22 of the problem. If controllable source 22 detects no voltage at 13 then it may be able to troubleshoot and correct the problem. If the problem cannot be corrected and if energy storage device can use plug 200 then controllable power source 22 can charge energy storage device 5 if energy storage device 5 is moved to plug 200. This is possible if plug 200 has a higher power rating than plug 100. If the problem were reversed and plug 200 were bad then device 5 would still be able to be charged at plug 100 but at a lower power level than at plug 200.

Thus there have been shown and described various power request configurations that allow flexible control of electric power by power consuming equipment. It is to be understood that the above-described embodiments of the invention are merely illustrative of many possible embodiments, which represent applications of the principle of the present invention. It should noted that a controllable power source may be able to provide many types of electrical power such as one level direct current, pulsed direct current, or any other wave form, alternating current in various power configurations such as one phase, two phase, three phase, WYE, delta etc. It therefore should be obvious that these or other electrical parameters may be requested by the energy storage device being charged without deviating from the spirit of the present invention. Numerous varied other arrangements can be readily devised in accordance with these principles by those skilled in the art without departing from the spirit and scope of the invention.

What is claimed is:

1. An energy storage device charger capable of providing electrical power to more than one energy storage device at the same power output port without damaging either energy storage device, when at least one said energy storage device has a power requirement that would damage the other said energy storage device comprising:
an electrical power feed;
a power source that uses power from said power feed to develop a power output;
means for said power source to vary the level of at least one continuously variable power parameter of said power output to off, full on, and at least one level between off and full on, said means for said power source to vary said level being controllable by a power request;
means for said power source to receive said request from a power-requesting device;
a first energy storage device;
a second energy storage device that would be damaged if it received power used to charge said first energy storage device;
means for said power-requesting device to be programmed with a power request, said request satisfying power requirements of said first energy storage device;
means to deliver said power output to said first energy storage device;
means to remove said first energy storage device and replace it with said second energy storage device, said programmable power-requesting device having a reprogrammed power request satisfying power requirements of said second energy storage device;
means to deliver said power output to said second energy storage device.

2. The energy storage device charger of claim 1 wherein said programmable power-requesting device is removable and replaceable with another power-requesting device, said first energy storage device using a first power-requesting device having a programmed first power request satisfying the power requirements of said first energy storage device;
said second energy storage device using a second power-requesting device having a programmed second power request satisfying the power requirements of said second energy storage device.

3. The energy storage device charger of claim 1 or 2 wherein said power-requesting device may have a programmed power request, but also has means to develop a power request using information about specifications of said energy storage device and also using sensor information from said energy storage device.

4. The energy storage device of claim 3 wherein said power-requesting device also uses sensor information about said power output.

5. The device charger of claim 1, 2, 3, or 4 wherein said power source has more than one said power output port; said power source having means to select one said power output port, said output port delivering said requested power to said energy storage device.
